(19) United States
(12) Patent Application Publication
(10) Pub. No.: US 2025/0270900 A1
(43) Pub. Date: Aug. 28, 2025

(54) CAPILLARY LINE INTRODUCTION AND WITHDRAWAL OF GASES FROM A SUBTERRANEAN STORAGE FORMATION

(71) Applicant: SAUDI ARABIAN OIL COMPANY, Dhahran (SA)

(72) Inventor: Abdulaziz S. AL-QASIM, Dhahran (SA)

(73) Assignee: SAUDI ARABIAN OIL COMPANY, Dhahran (SA)

(21) Appl. No.: 18/584,449

(22) Filed: Feb. 22, 2024

(51) Int. Cl. E21B 41/00; C09K 8/594

(52) U.S. Cl. CPC E21B 41/0064; C09K 8/594

(57) ABSTRACT

It may be desirable to store and produce gases from a subterranean storage formation on an as-needed basis. This action may be accomplished with a capillary line injector system. Methods may comprise: introducing one or more gases into a subterranean storage formation via a capillary line injector system comprising one or more capillary lines; storing at least a portion of the one or more gases within the subterranean storage formation; and optionally producing at least a portion of the one or more gases from the subterranean storage formation. The one or more gases are compressed before or while being introduced to the subterranean storage formation.

### FIELD OF THE DISCLOSURE

The present disclosure relates to systems and methods for introduction and withdrawal of gases from a subterranean storage formation.

### BACKGROUND

As concerns over climate change continue to increase, there is growing interest in mitigating the effects of industrial processes, such as cement and steel production, and combustion processes utilizing fossil fuels. Carbon Capture and Storage (CCS) is one approach that has been suggested for mitigating the effects of carbon dioxide and other greenhouse gases. CCS delivers captured greenhouse gases to a subterranean storage formation from short-to long-term storage. Other gases associated with environmentally friendly energy storage and use may similarly be housed in a subterranean storage formation and also play a role in CCS. For example, hydrogen may also be stored in a subterranean storage formation as a clean energy source.

Transportation of gases to the subterranean storage formation is typically conducted using steel pipelines of a wellbore. However, there are challenges in transporting CO₂ and other gases through standard pipelines. Carbon dioxide may contain corrosive gases, such as hydrogen sulfide, and itself may be corrosive, and hydrogen may lead to metal embrittlement. Expensive metallurgies and high gas pressures may be needed for conventional pipeline introduction of gases to a subterranean storage formation.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

In various embodiments, methods of the present disclosure comprise introducing one or more gases into a subterranean storage formation via a capillary line injector system comprising one or more capillary lines; and storing the one or more gases within the subterranean storage formation; wherein the one or more gases are compressed before or while being introduced to the subterranean storage formation.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a diagram of a non-limiting system and method of the present disclosure utilizing a capillary line injector system for introducing one or more gases downhole.

FIG. 2 is a block diagram of a non-limiting system and method generating and storing green hydrogen obtained from electrolyzed water.

FIG. 3 is a graph of fluid pressure in a capillary line as a function of depth below the earth's surface for various introduction rates and introduction pressures.

### DETAILED DESCRIPTION

The present disclosure relates to systems and methods for introduction and withdrawal of gases from a subterranean storage formation.

As discussed above, there is growing interest in storing greenhouse gases and other gases in subterranean storage formations as part of Carbon Capture and Storage (CCS) strategies. Capturing and pressurizing gases for subsequent storage in a subterranean storage formation may be problematic. In addition, transportation of carbon dioxide and other corrosive gases may increase operational costs and process complexity. Delivery of other gases downhole, such as hydrogen, may also be problematic in various respects.

As a solution to the foregoing issues, the present disclosure provides methods for introduction and production of gases from a subterranean storage formation using a capillary line injector system. Capillary lines are typically used in the oilfield for precision delivery of fluids during downhole chemical treatments. Because of their small volume, capillary lines offer low material and operational costs, as well as relatively easy installation compared to larger downhole pipelines. In the context of gas introduction, capillary lines may advantageously facilitate use of much smaller compressors during gas introduction compared to conventional CCS strategies, and the small volume of capillary lines may decrease costs associated with complicated metallurgies, if needed for particular process implementations. Further advantageously, capillary lines may tolerate introduction of highly pressurized gases, which may allow significant masses of gas to be stored downhole.

Accordingly, methods of the present disclosure may comprise: introducing one or more gases into a subterranean storage formation via a capillary line injector system comprising one or more capillary lines; and storing at least a portion of the one or more gases within the subterranean storage formation, in which the one or more gases are compressed before or while being introduced to the subterranean storage formation. The capillary line injector system may further comprise a suitable compressor for pressurizing the one or more gases in preparation for introduction to the subterranean storage formation. The capillary line injector system may further include a gas capture apparatus, or a gas capture apparatus may be coupled to the capillary line injector systems to facilitate capturing and delivery of the one or more gases into the subterranean storage formation.

Compression of the one or more gases captured in preparation for delivery into the subterranean storage formation may utilize one or more compressors that are configured to introduce a compressed gas into the capillary line injector system. Particular configurations and types of the one or more compressors are not believed to be especially limited. In some examples, the one or more compressors may utilize liquid injection when pressurizing the one or more gases. In non-limiting examples, the one or more compressors may be cooled by the liquid injection. The liquid injection may be advantageous for high-pressure environments while still maintaining operations at low temperatures. In some embodiments, the one or more compressors may be powered by a renewable energy source such as solar energy.

The gas capture apparatus may bear some similarities to conventional gas chromatographs. In non-limiting examples, the gas capture apparatus may include a heated injection port and a column housed within a temperature-controlled space, such as a temperature-controlled oven. A gas supply containing one or more gases may be injected into a port to vaporize the gas, and the vaporized gas(es) may then flow into a separation medium, typically with a carrier gas such as helium, before being introduced into the one or more compressors.

In various embodiments, real-time monitoring and control systems for gas capture and compression may be applied, which may facilitate proactive alteration of various process parameters to maintain performance and efficiency. The monitoring and control system may be driven by a plurality of computational algorithms designed to implement performance requirements for application-specific needs.

The capillary line injector system may comprise one or more capillary lines, such as 1 to about 10 capillary lines, or 1 to about 5 capillary lines. The number of capillary lines may be varied depending, for example, upon the number of locations within the subterranean storage formation to which the one or more gases need to be delivered. Unless needed in response to application-specific requirements, the capillary lines are not limited in metallurgy or design, and may be installed in a flowing or static well. Optionally, the capillary lines may be deployed in a well penetrating a subterranean storage formation that has been depleted or hydrocarbons or another natural resource. The capillary lines may be in communication with the compressor to facilitate delivery of the one or more gases into the subterranean storage formation in a suitably pressurized state. Because of their versatility, capillary lines may be used in wells located in remote areas.

In various embodiments, the one or more capillary lines may comprise a tubing having a wall thickness of about 0.035″ to about 0.065″ (inches), which may accommodate a range of typical working pressures. The one or more capillary lines may have an internal surface roughness of about 0.4 mm or less.

In various embodiments, the metallurgy of the capillary lines may comprise various metal alloys, such as steel alloys, or hybrid alternatives and non-metals as appropriate for the environment in which the capillary line injector system is functioning. In non-limiting examples, in a shallow subterranean storage formation, the capillary lines may comprise a non-metallic material due to favorable low thermal and electrical conductivity, or a carbon-based structure such as carbon nanotubes or carbon fibers. In some or other non-limiting examples, one or more capillary lines in a deeper subterranean storage formation may comprise alloys such as TP316L and Alloy 400 due to their high durability and resistance to corrosion.

The range of working pressures may be any pressure above atmospheric pressure up to about 20,000 psi, such as about 3500 psi or above, or about 5000 psi or above, or about 7500 psi or above, or about 10,000 psi or above, or about 15,000 psi or above. The differential pressure at the compressor (relative to the pressure within the subterranean storage reservoir) may be at least about 1500 psi.

The nature of the subterranean storage formation is not believed to be particularly limited, provided that sufficient void space is present to accommodate storage of the one or more gases. In non-limiting examples, the subterranean storage formation may comprise a depleted formation, such as a depleted hydrocarbon reservoir or a depleted aquifer. Accordingly, examples of suitable subterranean storage formations may include, but are not limited to, an aquifer, a shallow reservoir, a depleted hydrocarbon reservoir (inclusive of oil and/or gas reservoirs), a salt cavern, an aquifer, or any combination thereof. The subterranean storage formation may be penetrated by an existing well, or a new well may be drilled into the subterranean storage reservoir to facilitate placement of the one or more capillary lines.

At least a portion of the one or more gases introduced to the subterranean storage formation may be maintained (stored) therein. The one or more gases may comprise a single gas, two or more gases, or a mixture of two or more gases. Mixtures of two or more gases may be stored in multiple locations within the subterranean storage formation, optionally with the matrix of the subterranean storage formation promoting at least partial separation of the two or more gases downhole. Similarly, single gases containing an impurity may undergo at least partial separation from the impurity downhole by virtue of their passage through the matrix of the subterranean storage formation.

In some examples, the one or more gases may comprise two or more gases, and a first of the two or more gases may be stored in a first location of the subterranean storage. For example, a first of the two or more gases may comprise carbon dioxide, and a second of the two or more gases may comprise hydrogen. The two or more gases may be stored in the same location in the subterranean storage formation or in different locations, preferably in different locations so that the two or more gases may remain separated from one another and are removable therefrom separately. Preferably, the two or more gases are introduced to the subterranean storage formation separately, such as through two or more separate capillary lines or two or more groups of separate, multiple capillary lines.

As indicated previously, the one or more gases may comprise carbon dioxide, hydrogen, or any combination thereof. The one or more gases may be introduced to the subterranean storage formation through the one or more capillary lines in a gaseous state, as a liquefied gas, or as a supercritical fluid (e.g., supercritical carbon dioxide). The origin of the carbon dioxide and/or hydrogen is not particularly limited. In non-limiting examples, carbon dioxide may be captured from the atmosphere, a combustion process, at a wellhead, or any combination thereof. Hydrogen may be produced by an electrolysis process, preferably using solar energy, and subsequently stored in the subterranean storage formation. Such hydrogen may be referred to as “green hydrogen” due to the environmentally friendly nature of water electrolysis processes. Additional details regarding water electrolysis will be familiar to persons having ordinary skill in the art.

Stored carbon dioxide is preferably maintained in the subterranean storage formation for an extended period of time, including even permanently, in order to reduce the environmental burden of this greenhouse gas. In some cases, however, production of at least some of the stored carbon dioxide may be desirable if the carbon dioxide is to be sold as a commodity gas and/or used as a starting material for making various chemicals.

Stored hydrogen may be produced from the subterranean storage formation and used, as needed, to produce electrical power. The electrical power that is produced may be referred to herein as “green energy,” since hydrogen combustion produces water vapor as a product, rather than a greenhouse gas such as carbon dioxide. The green energy may be supplied to an electrical grid for consumer use. Optionally, at least a portion of the green energy may be supplied to the electrolysis process producing the green hydrogen.

Embodiments of the present disclosure will now be described in detail with reference to the accompanying Figures. Like elements in the various figures may be denoted by like reference numerals for consistency. Additionally, it will be apparent to one of ordinary skill in the art that the scale of the elements presented in the accompanying Figures may vary without departing from the scope of the present disclosure.

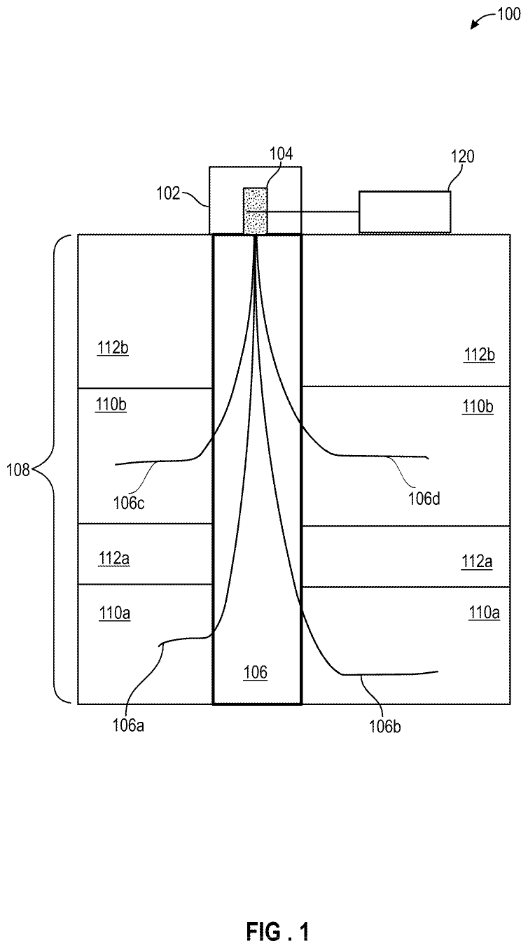

FIG. 1 is a diagram of a non-limiting system and method of the present disclosure utilizing a capillary line injector system for introducing one or more gases downhole. As shown, system and method 100 includes capillary line injector system 104 at wellhead 102 of wellbore 106. Wellbore 106 penetrates subterranean storage formation 108, which contains multiple storage locations 110a,b and scaling layers 112a,b. Capillary line injector system 104 includes multiple capillary lines 106a-d, which extend to a desired storage location. As shown, capillary lines 106a and 106b establish fluid communication between wellhead 102 and storage location 110a, and capillary lines 106c and 106d establish fluid communication between wellhead 102 and storage location 110b. Capillary lines 106a,b allow a first gas (e.g., carbon dioxide) to be delivered to and stored in storage location 110a, and capillary lines 106c,d allow a second gas (e.g., hydrogen) to be delivered to and stored in storage location 110b. Alternately, capillary lines 106a,b allow a first portion of gas (e.g., a first portion of hydrogen) to be delivered to and stored in storage location 110a, and a second portion of the gas (e.g., a second portion of hydrogen) to be delivered to and stored in storage location 110b. Sealing layers 112a,b aid in maintaining the gas within storage locations 110a,b, respectively. Sealing layers 112a,b may be a relatively impermeable layer, such as cap rock, for example.

To deliver the gas(es) to capillary line injector system 104 in a desired pressurization state, compressor 120 may be present. Compressor 120 may receive the gas(es) from a gas capture apparatus (not shown) or an electrolysis cell (not shown) and pressurize the gas(es) to a desired pressure prior to delivery downhole using capillary lines 106a-d.

Although FIG. 1 has depicted two storage locations 110a,b and sealing layers 112a,b, it is to be appreciated that the present disclosure is not limited in this respect. Any number of storage locations and sealing layers greater than or equal to one may be used in the disclosure herein. Similarly, capillary line injector system 104 need not necessarily have four capillary line 106a-d as shown. Any number of capillary lines greater than or equal to one may be used in the disclosure herein.

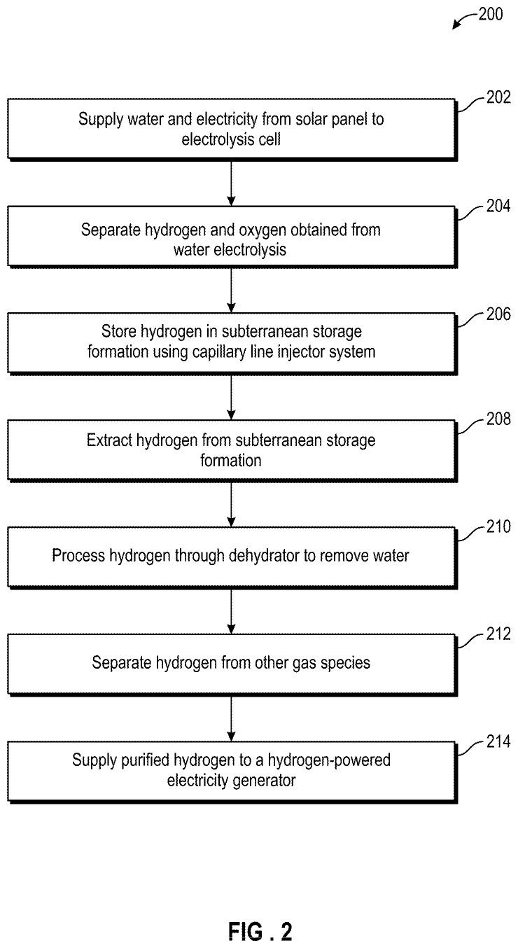

FIG. 2 is a block diagram of a non-limiting system and method 200 for generating and storing green hydrogen from electrolyzed water. At block 202, water and electricity (e.g. solar panel generated energy) are supplied to an electrolysis cell. The source of the water is not particularly limited and may comprise produced water in one or more examples. At block 204, the water is subjected to electrolysis, and hydrogen and oxygen are separated. At block 206, the separated gases are introduced into a subterranean storage formation, preferably separately, using a capillary line injector system and a compressor (FIG. 1). At least hydrogen is stored in the subterranean storage formation at block 206. Oxygen produced from the water electrolysis may also be optionally stored in the subterranean storage formation.

After a desired period of time, the hydrogen may be withdrawn from the subterranean storage formation. At block 208, stored hydrogen is extracted from the subterranean storage formation via the capillary lines that previously introduced the gases to the subterranean storage formation. At block 210, the hydrogen is processed through a dehydrator to remove excess water. The dehydrator may operate within a temperature ranging from about 30° C. to about 75° C., for example. At block 212, the hydrogen is further separated from other gas species. For example, the separation may take place in a pressure swing absorption apparatus.

At block 214, the purified hydrogen is supplied to a hydrogen-powered electricity generator. The electricity may be supplied to an electrical grid or used directly by an operator for a non-grid process. Optionally, at least a portion of the purified hydrogen may be transported to a hydrogen storage unit upon the earth's surface. Further optionally, at least a portion of the electricity may be utilized to conduct the water electrolysis at block 204.

Embodiments disclosed herein include:

A. Methods for storing one or more gases in a subterranean storage formation. The methods comprise: introducing one or more gases into a subterranean storage formation via a capillary line injector system comprising one or more capillary lines; and storing at least a portion of the one or more gases within the subterranean storage formation; wherein the one or more gases are compressed before or while being introduced to the subterranean storage formation.

Embodiment A may have one or more of the following elements in any combination:
Element 1: wherein the capillary line injector system further comprises a gas capture apparatus.
Element 2: wherein the capillary line injector system further comprises a compressor and the one or more gases are compressed by the capillary line injector system.
Element 3: wherein the one or more capillary lines have a wall thickness of about 0.035″ to about 0.065″.
Element 4: wherein the one or more capillary lines have an interior surface roughness of about 0.4 mm or less.
Element 5: wherein the one or more gases are compressed to a pressure of at least about 3500 psi up to a maximum working pressure of the one or more capillary lines, with a differential pressure of at least about 1500 psi.
Element 6: wherein the subterranean storage formation is selected from the group consisting of a depleted formation, a salt formation, a depleted aquifer, and any combination thereof.
Element 7: wherein the one or more gases comprise carbon dioxide, hydrogen, or any combination thereof.
Element 8: wherein the one or more gases are introduced to the subterranean storage formation in a supercritical state.
Element 9: wherein the one or more gases comprise two or more gases, and a first of the two or more gases is stored in a first location of the subterranean storage formation and a second of the two or more gases is stored in a second location of the subterranean storage formation.
Element 10: wherein at least a portion of the one or more gases is captured at an oil and gas well.
Element 11: wherein at least a portion of the one or more gases is captured from a combustion process.
Element 12: wherein the one or more gases comprise carbon dioxide.
Element 13: wherein the one or more gases comprise hydrogen.
Element 14: wherein the method further comprises producing the hydrogen from the subterranean storage formation; and using the hydrogen to generate electrical power.
Element 15: wherein the hydrogen is a product of electrolysis.
Element 16: wherein the electrolysis is powered by solar energy.

By way of non-limiting example, exemplary combinations applicable to A include, but are not limited to: 1 and/or 2, and 4; 1 and/or 2, and 5; 1 and/or 2, and 6; 1 and/or 2, and 7; 1 and/or 2, and 8; 1 and/or 2, and 9; 1 and/or 2, and 10; 1 and/or 2, and 11; 1 and/or 2, and 12; 1 and/or 2, and 13; 1 and/or 2, 13, and 15; 5 and 6; 5 and 7; 5 and 8; 5 and 9; 5 and 10; 5 and 11; 5 and 12; 5 and 13; 5, 13, and 15; 6 and 7; 6 and 8; 6 and 9; 6 and 10; 6 and 11; 6 and 12; 6 and 13; 6, 13, and 15; 7 and 8; 7 and 9; 7 and 10; 7 and 11; 13 and 14; 13 and 15; and 13-15.

Additional embodiments disclosed herein include:

Embodiment 1. A method comprising:
introducing one or more gases into a subterranean storage formation via a capillary line injector system comprising one or more capillary lines; and
storing at least a portion of the one or more gases within the subterranean storage formation;
   wherein the one or more gases are compressed before or while being introduced to the subterranean storage formation.

Embodiment 2. The method of Embodiment 1, wherein the capillary line injector system further comprises a gas capture apparatus.

Embodiment 3. The method of Embodiment 1 or Embodiment 2, wherein the capillary line injector system further comprises a compressor and the one or more gases are compressed by the capillary line injector system.

Embodiment 4. The method of any one of Embodiments 1-3, wherein the one or more capillary lines have a wall thickness of about 0.035″ to about 0.065″.

Embodiment 5. The method of any one of Embodiments 1-4, wherein the one or more capillary lines have an interior surface roughness of about 0.4 mm or less.

Embodiment 6. The method of any one of Embodiments 1-5, wherein the one or more gases are compressed to a pressure of at least about 3500 psi up to a maximum working pressure of the one or more capillary lines, with a differential pressure of at least about 1500 psi.

Embodiment 7. The method of any one of Embodiments 1-6, wherein the subterranean storage formation is selected from the group consisting of a depleted formation, a salt formation, a depleted aquifer, and any combination thereof.

Embodiment 8. The method of any one of Embodiments 1-7, wherein the one or more gases comprise carbon dioxide, hydrogen, or any combination thereof.

Embodiment 9. The method of any one of Embodiments 1-8, wherein the one or more gases are introduced to the subterranean storage formation in a supercritical state.

Embodiment 10. The method of any one of Embodiments 1-9, wherein the one or more gases comprise two or more gases, and a first of the two or more gases is stored in a first location of the subterranean storage formation and a second of the two or more gases is stored in a second location of the subterranean storage formation.

Embodiment 11. The method of any one of Embodiments 1-10, wherein at least a portion of the one or more gases is captured at an oil and gas well.

Embodiment 12. The method of any one of Embodiments 1-10, wherein at least a portion of the one or more gases is captured from a combustion process.

Embodiment 13. The method of any one of Embodiments 1-12, wherein the one or more gases comprise carbon dioxide.

Embodiment 14. The method of any one of Embodiments 1-12, wherein the one or more gases comprise hydrogen.

Embodiment 15. The method of Embodiment 14, further comprising:
producing the hydrogen from the subterranean storage formation; and
using the hydrogen to generate electrical power.

Embodiment 16. The method of Embodiment 14 or Embodiment 15, wherein the hydrogen is a product of electrolysis.

Embodiment 17. The method of Embodiment 16, wherein the electrolysis is powered by solar energy.

### Examples

Simulations were performed using the WellCAT software (Halliburton Energy Services) to test the feasibility of utilizing a capillary line injector system for downhole gas introduction, using an input of pure or impure gas, such as carbon dioxide, oxygen, or hydrogen.

For the initial simulation runs, pure carbon dioxide was introduced into the capillary lines at a surface temperature of 40° C. and a bottomhole temperature of 71.11° C., and at a pump pressure of 3500 psi and a reservoir pressure of 2000 psi (1500 psi differential). Under the foregoing temperature and pressure conditions, the carbon dioxide may exist in a supercritical state. In a supercritical state, the density of carbon dioxide at 40° C. is 873.07 kg/m³ and the dynamic viscosity is 0.003239 cP. By comparison, the density of gaseous carbon dioxide at atmospheric pressure is 1.696 kg/m³ at 40° C., and the dynamic viscosity is 0.01566 cP.

In general, carbon dioxide may exist in a supercritical state above the critical point of 1071 psi and 31.1° C.

The outer diameter (OD) of the capillary lines was fixed at 0.5″, and the wall thickness (WT) was varied relative to a control thickness of 0.065″. The inner surface roughness was fixed at 0.4 mm, and the capillary line length was fixed at 18,000 ft.

For the initial simulation runs, the flow rate for introduction of the supercritical carbon dioxide was simulated at 0.8 gal/min. Taking the density of supercritical carbon dioxide (873.07 kg/m³=7.286 lb/gal) and multiplying by the flow rate gives a rate of carbon dioxide introduction to the subterranean storage formation of 5.828 lb/min. This value equates to a gas-equivalent rate of introduction of 79,228.80 scf/day. Table 1 summarizes the working pressure ranges for capillary lines constructed from steel alloys and having different wall thicknesses.

TABLE 1

| | | Welded | | | | | | |
|---|---|---|---|---|---|---|---|---|
| | | | Min. | Min. | Theoretical | Theoretical | Theoretical | Recommended |
| | | | Tensile | Yield | Collapse | Burst | Working | Test |
| Size/Type | | | Strength | Strength | Pressure² | Pressure² | Pressure² | Pressure |
| OD | WT | Alloy | (psi) | (psi) | (psi) | (psi) | (psi) | (psi) |
| 0.500 | 0.035 | 316L | 75000 | 30000 | 3500 | 10000 | 3000 | 3700 |
| | | 825 | 85000 | 35000 | 4100 | 11300 | 3500 | 4300 |
| | | 825E | 95000 | 60000 | 7000 | 12700 | 6000 | 7300 |
| | | 625 | 120000 | 60000 | 7000 | 16000 | 6000 | 7300 |
| | | 2205 | 95000 | 70000 | 8200 | 12700 | 7000 | 8500 |
| 0.500 | 0.049 | 316L | 75000 | 30000 | 4800 | 14300 | 4300 | 5200 |
| | | 825 | 85000 | 35000 | 5600 | 16200 | 5000 | 6100 |
| | | 825E | 95000 | 60000 | 9600 | 18200 | 8600 | 10400 |
| | | 625 | 120000 | 60000 | 9600 | 23000 | 8600 | 10400 |
| | | 2205 | 95000 | 70000 | 11200 | 18200 | 10000 | 12100 |
| 0.500 | 0.065 | 316L | 75000 | 30000 | 6100 | 19500 | 5800 | 7100 |
| | | 825 | 85000 | 35000 | 7200 | 22100 | 6800 | 8300 |
| | | 825E | 95000 | 60000 | 12300 | 24700 | 11700 | 14100 |
| | | 625 | 120000 | 60000 | 12300 | 31200 | 11700 | 14100 |
| | | 2205 | 95000 | 70000 | 14400 | 24700 | 13700 | 16500 |
| 0.500 | 0.083 | 316L | 75000 | 30000 | 7600 | 25500 | 7600 | 9300 |
| | | 825 | 85000 | 35000 | 8800 | 28900 | 8900 | 10800 |
| | | 825E | 95000 | 60000 | 15200 | 32300 | 15300 | 18500 |
| | | 625 | 120000 | 60000 | 15200 | 40800 | 15300 | 18500 |
| | | 2205 | 95000 | 70000 | 17700 | 32300 | 17900 | 21500 |

As shown, a pump pressure of 3500 psi is accommodated by most of the wall thicknesses and materials specified in Table 1. Therefore, an introduction rate of 5.828 lb/min=79,228.80 scf/day provides a minimum amount of carbon dioxide that may be suitably introduced downhole for storage using a capillary line injector system. That is, higher introduction rates may be accomplished by using higher pump pressures.

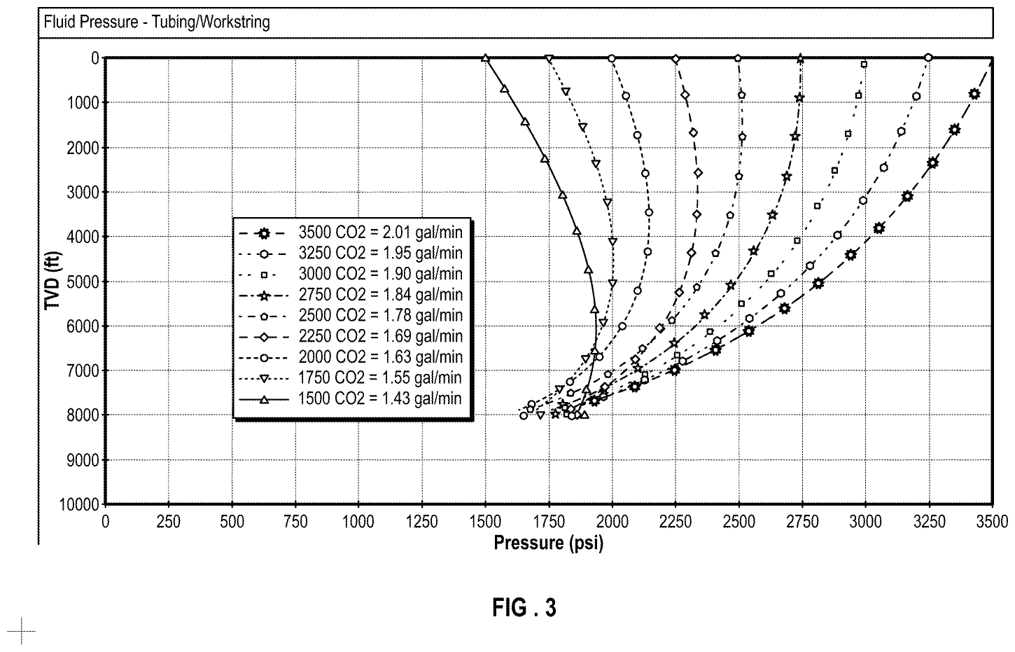

Next, the introduction rates and introduction pressure for the carbon dioxide were varied. FIG. 3 is a graph of fluid pressure in a capillary line as a function of depth below the earth's surface for various introduction rates and introduction pressures. The graph depicts fluid pressure in units of psi along the x-axis, and True Vertica Depth (TVD) along the y-axis. FIG. 3 includes CO₂ at various levels along with its corresponding flow rate (gal/min). This case study includes control conditions of a constant temperature, a consistent capillary wall thickness and material such as steel alloy, and an assumption that the CO₂ gas is incompressible. FIG. 3 demonstrates that as CO₂ levels and flow rate decrease, so in turn does the fluid pressure at a given depth. This would result in the reduction of frictional pressure loss in tubing as the density and viscosity decrease at lower pressures. Additionally, as the TVD increased, fluid pressure also increased, as is consistent with fluid dynamics.

In the detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.”

Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

The invention claimed is:

1. A method comprising:
introducing one or more gases into a subterranean storage formation via a capillary line injector system comprising one or more capillary lines; and
storing at least a portion of the one or more gases within the subterranean storage formation;
wherein the one or more gases are compressed before or while being introduced to the subterranean storage formation.

2. The method of claim 1, wherein the capillary line injector system further comprises a gas capture apparatus.

3. The method of claim 1, wherein the capillary line injector system further comprises a compressor and the one or more gases are compressed by the capillary line injector system.

4. The method of claim 1, wherein the one or more capillary lines have a wall thickness of about 0.035″ to about 0.065″.

5. The method of claim 1, wherein the one or more capillary lines have an interior surface roughness of about 0.4 mm or less.

6. The method of claim 1, wherein the one or more gases are compressed to a pressure of at least about 3500 psi up to a maximum working pressure of the one or more capillary lines, with a differential pressure of at least about 1500 psi.

7. The method of claim 1, wherein the subterranean storage formation is selected from the group consisting of a depleted formation, a salt formation, a depleted aquifer, and any combination thereof.

8. The method of claim 1, wherein the one or more gases comprise carbon dioxide, hydrogen, or any combination thereof.

9. The method of claim 1, wherein the one or more gases are introduced to the subterranean storage formation in a supercritical state.

10. The method of claim 1, wherein the one or more gases comprise two or more gases, and a first of the two or more gases is stored in a first location of the subterranean storage formation and a second of the two or more gases is stored in a second location of the subterranean storage formation.

11. The method of claim 1, wherein at least a portion of the one or more gases is captured at an oil and gas well.

12. The method of claim 1, wherein at least a portion of the one or more gases is captured from a combustion process.

13. The method of claim 1, wherein the one or more gases comprise carbon dioxide.

14. The method of claim 1, wherein the one or more gases comprise hydrogen.

15. The method of claim 14, further comprising:
producing the hydrogen from the subterranean storage formation; and
using the hydrogen to generate electrical power.

16. The method of claim 14, wherein the hydrogen is a product of electrolysis.

17. The method of claim 16, wherein the electrolysis is powered by solar energy.
